(19) United States
(12) Patent Application Publication
(10) Pub. No.: US 2004/0042491 A1
(43) Pub. Date: Mar. 4, 2004

(54) Synchronization of data packet numbers in packet-switched data transmission

(76) Inventors: Sinikka Sarkkinen, Kangasala (FI); Ari Tourunen, Espoo (FI); Sari Maija Leppanen, Helsinki (FI); Juha Kalliokulju, Vesilahti (FI)

Correspondence Address: Crawford Maunu PLLC, Suite 390, 1270 Northland Drive, St. Paul, MN, 55120, US

(21) Appl. No.: 10/371,026

(22) Filed: Feb. 20, 2003

Related U.S. Application Data
(63) Continuation of application No. PCT/FI01/00731, filed on Aug. 20, 2001.

(30) Foreign Application Priority Data
Aug. 21, 2000 (FI) 20001846

(51) Int. Cl. H04J 3/16

(52) U.S. Cl. 370/469; 370/466

(57) ABSTRACT

A method for acknowledged transmission of data packets in a telecommunications system, comprising a convergence protocol layer for creating convergence protocol packets, and a link layer for transmitting convergence protocol packets and for acknowledging the transmission. A data packet number is defined for the convergence protocol packets by means of counters of the transmitter and the receiver which are synchronized with each other, in which case the transmitted convergence protocol packets are acknowledged by means of said counters. After reconfiguration of a radio bearer, the counters are synchronized by comparing the values of respective counters, and if the value of the transmitter's counter is smaller than the value of the receiver's counter, a temporary counter is started for the receiver. The value of the transmitter's counter is set as the value of the temporary counter, and the temporary counter is used until its value reaches a predetermined value.

This application is a Continuation of International Application PCT/FI01/00731 filed on Aug. 20, 2001, which designated the U.S. and was published under PCT Article 21(2) in English.

### BACKGROUND OF THE INVENTION

The invention relates to packet-switched data transmission and particularly to synchronization of data packet numbers in acknowledged data transmission.

In addition to circuit-switched services, which are typically speech services, the third-generation mobile communication systems, which are also called e.g. the UMTS (Universal Mobile Telecommunications System) and the IMT-2000 (International Mobile Telephone System), will offer packet-switched services like the GPRS (General Packet Radio Service) packet radio network designed for the GSM system. Packet-switched data transmission enables the use of various data services through a mobile station, and allocation of resources of the mobile communication system, particularly those of the radio interface, to each user according to the need.

In packet-switched data transmission we can employ reliable, i.e. acknowledged, transmission or unreliable, i.e. unacknowledged, transmission. In acknowledged data transmission the receiver sends an acknowledgement of received data packets PDU (Protocol Data Unit) to the transmitter, and thus the trasnmitter can retransmit lost or damaged packets. The transmitter sets the data packets PDU in a buffer to wait for an acknowledgement of received packets or for a request to retransmit a lost or a damaged data packet. The transmitted data packets can be removed from the buffer as an acknowledgement of received data packets is received from the receiver.

To allow both the transmitter and the receiver to identify data packets that are to be acknowledged or requested again, the packets have to be identified in some way. This is done by defining a 16-bit data packet number, i.e. a PDCP-PDU number, for each data packet using the convergence protocol layer PDCP (Packet Data Convergence Protocol) of the data packet protocol. Transmission of this PDCP-PDU number with each data packet PDCP-PDU would increase the load in data transmission because two extra bytes would be transmitted in each data packet. For this reason, data packets are acknowledged in normal acknowledged data transmission on the basis of RLC numbering in an RLC layer (Radio Link Control) below the PDCP layer and acknowledgment of these numbers, in which case it is unnecessary to transmit PDCP-PDU numbers.

In some situations, e.g. during internal handover (SRNS relocation, Serving Radio Network Subsystem) between radio network subsystems of the UMTS, the RLC layer cannot, however, guarantee reliable acknowledgement of all data packets. For this reason, an arrangement known as virtual data packet numbering has been developed for the data packet protocol of the UMTS to maintain data packet numbering in the PDCP layer by means of counters. Both the transmitting PDCP and the receiving PDCP monitor the data packets to be transmitted by means of counters, and the receiving PDCP acknowledges received data packets by means of the counter reading, preferably in a manner corresponding to normal acknowledged data transmission, in which case data packet numbers need not be transmitted with the data packets. A transmission window is defined for the transmitter, and its size defines the largest value allowed for the number of unacknowledged data packets in the transmitter's buffer. In other words, a certain maximum number of data packets are transmitted, which the receiver has to acknowledge before new data packets can be sent. A maximum value is typically also defined for the transmitting RLC in the RLC layer, which is either a number of retransmissions or a period during which the transmitting RLC tries to retransmit an unacknowledged data packet. When this maximum value is exceeded and no acknowledgement has been received, the receiver is sent a message to reject reception of the data packet in question, add one to the value of the receiving counter value and prepare for receiving the next data packet. The receiver acknowledges these directions and transmission can continue from the next data packet.

A problem related to the arrangement described above is a situation in which the receiver's acknowledgement of rejection of the data packet does not reach the transmitter. The transmitter continues transmission of data packets until the number of data packets defined in the transmission window have been sent. Lack of acknowledgement may lead to a situation in which the RLC layer needs to be reset, in which case transmission of data packets included in the transmission window starts from the beginning in the PDCP layer. The transmitter's counter indicates the initial value of the transmission window in question but the receiver has typically received some or all of the data packets sent after the rejected data packet, and consequently the value in the receiver's counter is greater than that in the transmitter's counter. Furthermore, some data packets have been transmitted to the receiver twice and removal of these duplicates without errors constitutes a further problem.

### BRIEF DESCRIPTION OF THE INVENTION

An object of the invention is to provide an improved method and an apparatus implementing the method to minimize the above-mentioned disadvantages. The objects of the invention are achieved with methods which are characterized by what is disclosed in the independent claims.

The preferred embodiments of the invention are disclosed in the dependent claims.

The invention is based on comparing the sequence number counters of the transmitter and the receiver during reconfiguration of the radio bearer or reset of the RLC layer, and if the value of the transmitter's sequence number counter is smaller than the value of the receiver's sequence number counter, a temporary counter is used and the value of the receiver's sequence number counter is stored in memory and the value of the transmitter's sequence number counter is set as the value of the temporary counter. The value of the temporary counter is increased each time a new PDCP-PDU data packet is transmitted from the RLC layer. When the value of the temporary counter reaches the value of the receiver's sequence number counter stored in memory, the temporary counter is removed or attached to the receiver's original sequence number counter, and consequently the sequence number counters are synchronous again.

According to a preferred embodiment of the invention, it is presumed that the PDCP-PDU data packets received during the use of the temporary counter are duplicates of the data packets received earlier and they destroyed in the receiver's PDCP layer, and thus no duplicates are transmitted to the upper protocol layers.

According to an alternative embodiment of the invention, if asynchronous counters can be synchronized by sending convergence protocol packets which include a data packet number, i.e. PDCP-SeqNum-PDUs, and by indicating the number of convergence protocol packets to the receiver by some mechanism, the temporary counter described above is unnecessary. If the value of the transmitter's sequence number counter transmitted to the receiver is smaller than the value of the receiver's sequence number counter, the value of the receiver's sequence number counter is stored in memory and the data packet number of each received convergence protocol packet is compared with the value of the receiver's sequence number counter. It is presumed that each received PDCP-SeqNum-PDU data packet with a data packet number smaller than the value of the receiver's sequence number counter is a duplicate of a data packet received earlier and it is destroyed in the receiver's PDCP layer.

An advantage of the method according to the invention is that it allows to avoid error situations resulting from the fact that the applications used by the terminal cannot process duplicate data packets transmitted by the lower layers. A further advantage is that duplicate data packets are not forwarded from the PDCP layer on the network side, which reduces the load on network resources. This is particularly advantageous when the receiver of transmission is another mobile station because the load on the limited resources of the air interface can be reduced.

### BRIEF DESCRIPTION OF THE DRAWINGS

The invention will be described in greater detail by means of preferred embodiments with reference to the accompanying drawings, in which

FIG. 1 is a block diagram of the structure of the UMTS system;

FIG. 2 illustrates a protocol stack used for transmitting user data in the UMTS;

FIG. 3 is a block diagram illustrating a functional model of the PDCP layer;

FIG. 4 is a signalling chart illustrating acknowledged data transmission and acknowledgement of data packets in PDCP data transmission;

FIG. 5 is a signalling chart illustrating acknowledged data transmission which utilizes virtual data packet numbering, and acknowledgement of data packets in PDCP data transmission; and

FIG. 6 is a signalling chart illustrating an error situation resulting in asynchronization of data packet counters; and

FIG. 7 is a flow chart illustrating synchronization of data packet counters according to the invention.

### DETAILED DESCRIPTION OF THE INVENTION

In the following, the invention will be explained using as an example a packet radio service of the UMTS system, particularly internal handover between radio network subsystems of the UMTS (SRNS Relocation). However, the invention is not limited to the UMTS system, but may be applied to any packet-switched data transmission method in which virtual data packet numbering is used as will de described below. Consequently, the invention can be applied in acknowledged handover between the UMTS and the GPRS, for example, in which case the term receiving PDCP used in this description can be replaced with the corresponding function of the GPRS, i.e. SNDCP.

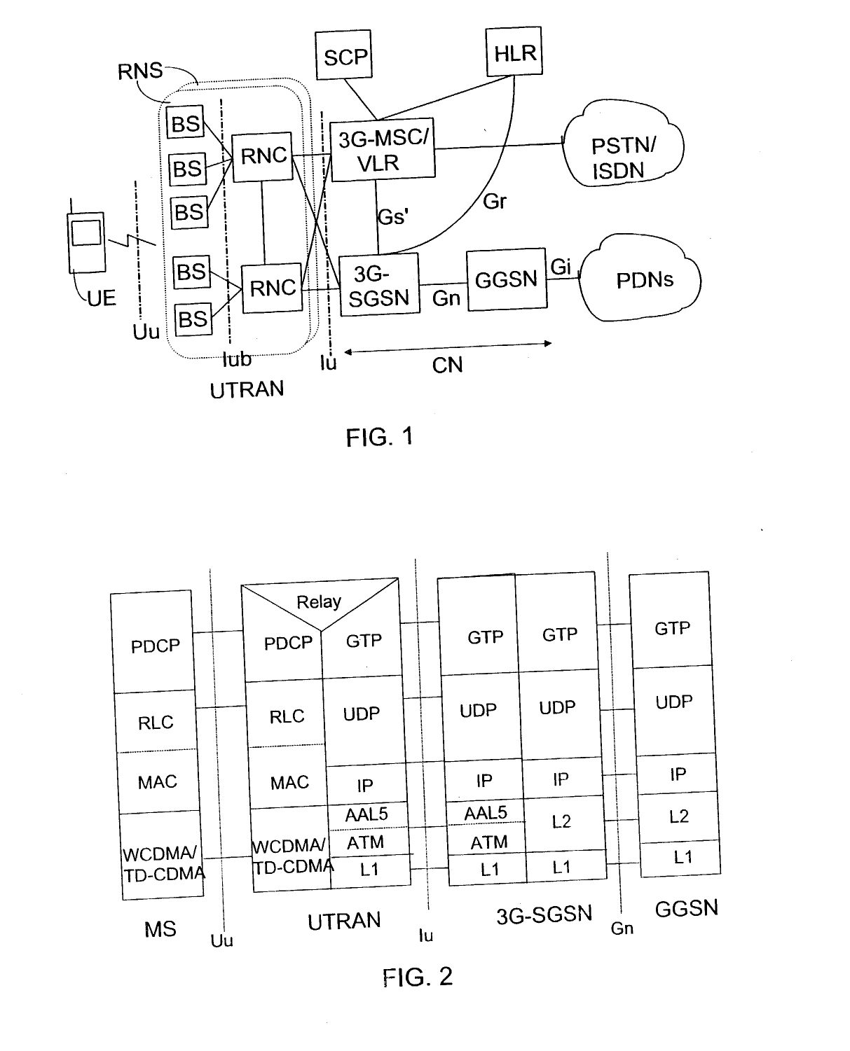

The structure of the UMTS mobile communication system will be described with reference to FIG. 1. FIG. 1 includes only the blocks relevant to describing the invention but it is obvious to a person skilled in the art that a conventional mobile communication system also comprises other functions and structures that need not be explained more closely in this context. The main elements of a mobile communication system are a core network CN and a UMTS terrestrial radio access network UTRAN, which form the fixed network of the mobile communication system, and a mobile station or user equipment UE. The interface between the CN and the UTRAN is called lu and the interface between the UTRAN and the UE is known as Uu.

The UTRAN typically consists of several radio network subsystems RNS between which there is an interface called lur (not shown). The RNS consists of radio network controllers RNC and one or more base stations BS, which are also called node Bs. The interface between the RNC and the BS is called lub. The base station BS is typically responsible for implementation of the radio path, and the radio network controller RNC at least for the following matters: radio resource management, controlling of handover between cells, power control, timing and synchronization, paging of subscriber terminals.

The core network CN consists of infrastructure belonging to a mobile communication system outside the UTRAN. In the core network, a mobile switching centre/visitor location register 3G-MSCNLR communicates with a home location register HLR and preferably also with a service control point SCP of the intelligent network. The home location register HLR and the visitor location register VLR contain information on mobile subscribers: the home location register HLR contains information on all subscribers of the mobile communication network and on the services ordered by them, and the visitor location register VLR contains information on mobile stations which visit the area of a certain mobile switching centre MSC. The connection to a serving GPRS support node 3G-SGSN of the radio system is established via a Gs' interface and to a public switched telephone network PSTN/ISDN via a gateway mobile switching centre GMSC (Gateway MSC, not shown). A connection is established from the serving support node 3G-SGSN to the gateway GPRS support node GGSN via a Gn interface, and further from the GGSN to external data networks PDN. Both the mobile switching centre 3G-MSC/VLR and the serving support node 3G-SGSN communicate with the radio network UTRAN (UMTS Terrestrial Radio Access Network) via the lu interface. It should be noted that the UMTS system is designed so that the core network CN may be identical with the core network of the GSM system, for example, in which case the whole network infrastructure does not need to be rebuilt.

The UMTS system thus also comprises a packet radio system which is implemented to a great extent in accordance with the GPRS system connected to the GSM network, for which reason the names of the network elements contain references to the GPRS system. The packet radio system of the UMTS may comprise several serving support nodes and gateway support nodes, and typically several serving support nodes 3G-SGSN are connected to one gateway support node 3G-GGSN. Both the 3G-SGSN node and the 3G-GGSN node function as routers which support mobility of the mobile station and control the mobile communication system and route data packets to mobile stations regardless of their location and the protocol used. The serving support node 3G-SGSN communicates with a mobile station UE via the radio network UTRAN. The function of the serving support node 3G-SGSN is to detect mobile stations capable of packet radio connections in its area, send data packets to and receive them from these mobile stations and to monitor the location of the mobile stations in its service area. In addition, the serving support node 3G-SGSN communicates with the mobile switching centre 3G-MSC and the visitor location register VLR via the signalling interface Gs' and with the home location register HLR via the Gr interface. The home location register HLR also contains records which are related to the packet radio service and include the contents of subscriber-specific packet data protocols.

The gateway support node 3G-GGSN functions as a gateway between the packet radio system of the UMTS network and an external data network PDN (Packet Data Network). External data networks include a UMTS or a GPRS network of another network operator, the Internet, an X.25 network or a private local area network. The gateway support node 3G-GGSN communicates with these data networks via a Gi interface. The data packets to be transmitted between the gateway support node 3G-GGSN and the serving support node 3G-SGSN are always encapsulated according to a gateway tunnelling protocol GTP. The gateway support node 3G-GGSN also contains the PDP addresses (Packet Data Protocol) of mobile stations and the routing data, i.e. 3G-SGSN addresses. Thus the routing data are used for linking data packets between the external data network and the serving support node 3G-SGSN. The network between the gateway support node 3G-GGSN and the serving support node 3G-SGSN is a network which utilizes the IP protocol, preferably IPv6 (Internet Protocol, version 6).

In the UMTS, a protocol stack according to FIG. 2 is used in the transmission of packet-switched user data (user plane). At the interface Uu between the radio network UTRAN and the mobile station UE, lower-level data transmission is carried out according to the WCDMA or TD-CDMA protocol in the physical layer. Data packets are transmitted between the physical layer and the RLC layer (Radio Link Control) by a MAC layer (Media Access Layer) which is above the physical layer, and the RLC layer is responsible for logical management of radio links of different radio bearers. The functionalities of the RLC include segmentation of user data to be transmitted (RLC-SDU, Service Data Unit) into one or more RLC data packets RLC-PDU. The data packets (PDCP-PDU) of the PDCP layer on top of the RLC and the header fields related to them can be compressed, if desired. After this, the PDCP-PDUs, which correspond to one RLC-SDU, are supplied to the RLC. The user data and the RLC-SDUs are segmented and transmitted in RLC frames to which address and control information necessary for data transmission has been added. The RLC layer is also responsible for retransmission of damaged frames. The serving support node 3G-SGSN is responsible for routing the data packets arriving from the mobile station UE via the radio network RAN further to the correct gateway support node 3G-GGSN. This connection uses the tunnelling protocol GTP, which encapsulates and tunnels all the user data and signalling transmitted via the core network. The GTP protocol is run above the IP used by the core network.

One of the functions of the PDCP layer is to enable transmission of data packets PDCP-SDU received from the upper application-level layers further to lower link-level layers and vice versa transparently between the UMTS terminals and the elements of the radio network UTRAN. Thus the PDCP layer has to be adaptable so that it can also transmit data packets according to other network level protocols than the known IP protocols (IPv4, IPv6).

The tasks of the PDCP layer also include functions related to improvement of channel capacity, which are typically based on optimisation of data packet header fields by means of various compression algorithms. Since nowadays the network level protocols designed for the UMTS are IP protocols, the compression algorithms to be used are also algorithms standardised by the IETF (Internet Engineering Task Force). If necessary, any header field compression algorithm can be applied in the PDCP layer, the algorithm being naturally selected according to the network level protocol used. In addition, one of the functions of the PDCP layer is to transmit data packets PDCP-PDU and, if necessary, PDCP sequence numbers related to the packets to a new radio network subsystem in internal handover (SRNS Relocation) between radio network subsystems in the UMTS.

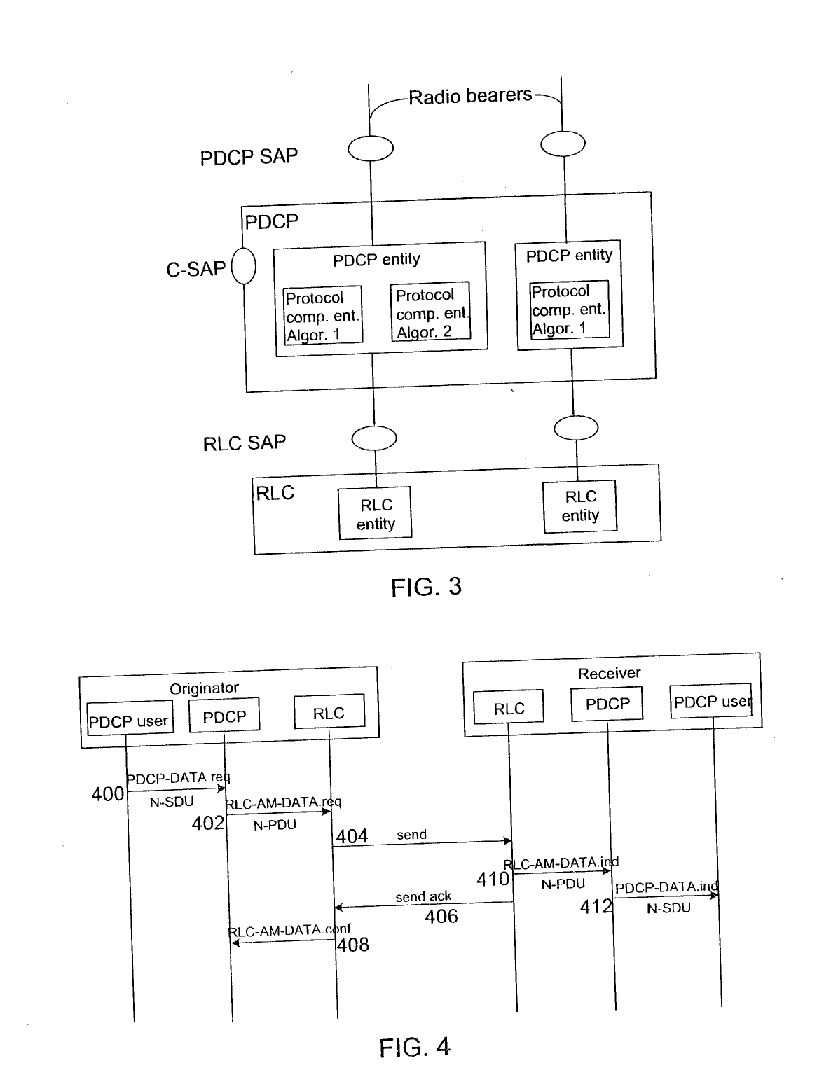

FIG. 3 shows a functional model of the PDCP layer in which one PDCP entity is defined for each radio bearer. Since in the existing systems a separate PDP context is defined for each radio bearer, one PDCP entity is also defined for each PDP context, and thus a certain RLC entity is defined for the entity in the RLC layer. In principle, the functions of the PDCP layer can be implemented by multiplexing several PDP contexts in the PDCP layer, in which case one RLC entity in the RLC layer below the PDCP layer receives data packets simultaneously from several radio bearers.

FIG. 4 shows how data transmission is acknowledged and how data packets travel when acknowledged transmission is used in PDCP data transmission. The PDCP entity receives a request (PDCP-DATA.request, 400) to transmit data packets from the user as well as data packets PDCP-PDU together with the request. The PDCP entity compresses the header fields of the data packets and sends the resulting data packets PDCP-PDU to the RLC layer (RLC-AM-DATA.request, 402) together with the identity data of the radio link. The RLC layer is responsible for transmitting (send, 404) data packets PDCP-PDU and for acknowledging successful transmission (send ack, 406). In the PDCP entity the data packets PDCP-SDU are inserted into a buffer, from which they are not removed until an acknowledgement (RLC-AM-DATA.conf, 408) of successful transmission of data packets to the receiver is received from the RLC layer. The receiving PDCP receives the PDCP-PDUs transmitted from the RLC layer (RLC-AM-DATA.indication, 410), in which case the PDCP entity decompresses the data packets PDCP-PDU. Thus the original data packets PDCP-SDU can be restored and will be forwarded to the user (PDCP-DATA.indication, 412).

In this connection it is possible to apply virtual numbering of data packets, which means that no separate data packet numbers are added to the data packets, but the counters are updated on the basis of the transmitted data packets and the receiving PDCP and the transmitting PDCP can ascertain successful transmission of data packets on the basis of counter values.

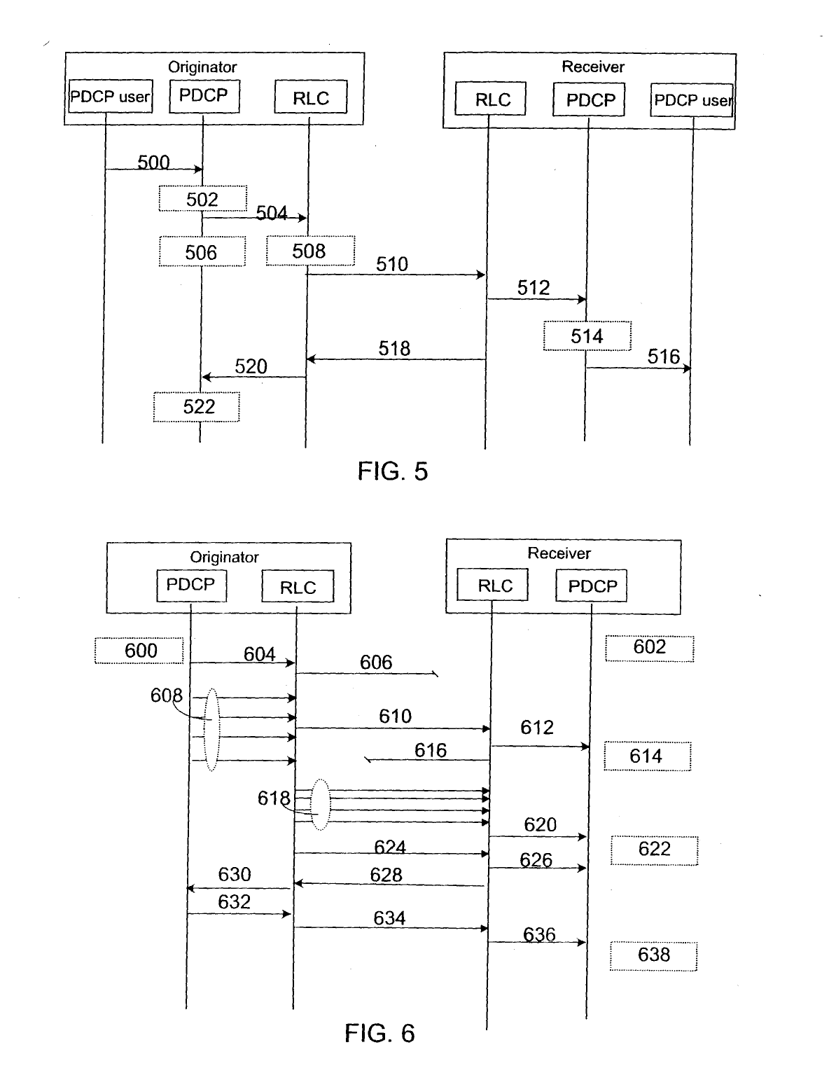

In virtual data packet numbering, a PDCP-PDU sequence number is defined for the first data packet of the packet data connection and a predetermined numerical value, e.g. 0, is set as the initial value for this number in the counter both in the transmitting PDCP and in the receiving PDCP. Data packet numbering is illustrated in greater detail in FIG. 5. When the transmitting PDCP receives (500) a data packet PDCP-SDU from the transmitter, it inserts the data packet into the PDCP-SDU buffer and logically adds a PDCP-PDU sequence number (502) to this data packet. The transmitting PDCP transmits the data packet PDCP-PDU and the PDCP-PDU sequence number logically attached to it to the RLC layer (504) and adds one (506) to the counter that determines the value of the PDCP-PDU sequence number. The RLC layer may also optionally define the ratio between the PDCP-PDU sequence number and the last RLC sequence number of the data packet and store in memory (508). The RLC layer is responsible for transmission of PDCP-PDU data packets between the transmitter and the receiver (510), the data packets PDCP-PDU being split into data units RLC-PDU for transmission and numbered with RLC sequence numbers. When the receiving PDCP receives (512) a data packet PDCP-PDU from the RLC layer, it adds one (514) to the counter that defines the value of the PDCP-PDU sequence numbers and transmits the data packet PDCP-SDU to the next layer (516). An acknowledgement of a successfully received data packet is sent to the transmitter (518) in the RLC layer, and the transmitting RLC transmits this acknowledgement to the transmitting PDCP (520). In response to the acknowledgement, the transmitting PDCP removes the data packet PDCP-SDU in question from the buffer (522). The correct data packet PDCP-SDU to be removed is determined preferably by means of a PDCP-PDU sequence number logically attached to the data packet.

When the radio bearer is established (RB establishment) or reconfigured, the terminal and the radio network negotiate the parameters of the radio bearer using signalling according to a radio resource control protocol RRC. The radio resource control protocol RRC is responsible e.g. for establishing, configuring, maintaining and terminating radio connections between the mobile station UE and the radio network UTRAN and for transmitting control information transmitted from the core network CN and the radio network RAN to the mobile stations UE. Furthermore, the RRC signalling is used for determining whether the radio bearer requires lossless handover between the radio network subsystems (lossless SRNS relocation). Lossless handover, in which data packets are not lost in the handover process, is needed in reliable data transmission which utilizes acknowledged transmission. This sets certain requirements for the RLC layer of the UMTS system: the RLC layer has to be in the acknowledgement mode and the RLC must be able to send the data packets in the right order.

The virtual data packet numbering described above also supports lossless handover between radio network subsystems, in which case acknowledgement of data packets can also be made to correspond to the acknowledgement of data packets in normal PDCP data transmission described above. In other words, virtual data packet numbering can also be used in normal acknowledged data transmission, in which the receiver and the transmitter remain the same, whereas in the handover process one party changes.

In some interference situations, e.g. when the network is congested or there is disturbance on the radio path, the RLC layer cannot guarantee acknowledged data transmission. A transmission window is defined for the transmitter and its size defines the largest value allowed for the number of unacknowledged data packets in the transmitter's buffer. Thus a certain maximum number of data packets are transmitted, which the receiver has to acknowledge before new data packets can be sent. A maximum value is typically defined for the transmitter RLC, which is either a number of retransmissions or a period during which the transmitting RLC tries to retransmit the same data packet. If the maximum value is exceeded, the RLC layer informs the PDCP layer of this. If a sent data packet disappears on the transmission path due to an interference situation and no acknowledgement thereof is received before the predetermined maximum value is exceeded, the receiver is sent a message to reject reception of this data packet, add one to the value of the receiving counter and prepare for receiving the next data packet. The receiver acknowledges these directions, and thus the transmitter also updates the counter value, and transmission can be continued from the next data packet. If the RLC layer can inform the PDCP layer of all lost data packets, the receiving PDCP can update the PDCP-PDU sequence number correctly, and thus the sequence number counters of the transmitting PDCP and the receiving PDCP remain synchronized.

However, it is possible that the same interference situation that has caused loss of data packets in the RLC layer also prevents the acknowledgement of the receiving RLC from reaching the transmitting RLC. In that case the transmitting RLC does not know that the receiving RLC has been informed of the lost data packet and that it has updated the sequence number counter of the receiving PDCP correctly. If the transmitting RLC does not receive an acknowledgement, the RLC-layer may have to be reset. The transmitter continues to transmit data packets until the number of data packets defined by the transmission window have been sent and if an acknowledgement of rejection of the lost data packet is still not received from the receiver, transmission of all the data packets included in the transmission window starts again. However, the receiver has typically received some or all of the data packets sent after the rejected data packet and updated the sequence number counter accordingly, as a result of which the PDCP-PDU sequence number counters in the transmitting PDCP and the receiving PDCP are asynchronous.

This situation can be illustrated with a signalling chart shown in FIG. 6. In the initial situation the sequence number counters (602) of both the transmitting PDCP (600) and the receiving PDCP (602) have the same value (N), which means that the counters are synchronized and the sequence number of the previous successfully transmitted data packet was (N−1). The transmitting PDCP transmits a data packet PDCP-PDU with sequence number N (604) to the transmitting RLC. The receiving RLC forwards this to the receiver (606) but due to some interference situation this data packet does not reach the receiver. The transmitting RLC tries to retransmit the same data packet and at the same time other data packets of the transmission window, M packets altogether, are transmitted from the transmitting PDCP to the RLC layer (608) for transmission. After the maximum value of retransmissions has been exceeded, the transmitting RLC gives the receiver directions to reject reception of the data packet in question, add one to the counter value and prepare for receiving the next data packet (610). The receiving RLC informs the receiving PDCP of this (612), which updates the value of the receiver's counter to N+1 (614). The receiving RLC also sends an acknowledgement (616) of the fact that rejection of the data packet has been registered, but this acknowledgement does not reach the transmitting RLC because of an interference situation. Thus the value of the transmitter's counter cannot be updated, and its value is still N. The transmitting RLC, however, continues transmission of all the data packets (M packets) (618), and the receiving RLC informs the receiving PDCP of each data packet (620), which updates the value of the receiver's counter to N+M (622).

Since the transmitting RLC has received no acknowledgement of rejection of the data packet N, the transmitter's counter still cannot be updated. For this reason the transmitting RLC is defined to start retransmission of the data packets included in the transmission window. The transmitting RLC informs the receiving RLC (624) of this, which acknowledges the message (626). The receiving RLC and the transmitting RLC also inform the PDCP-layer (628, 630) that the RLC-layer will be reset. The transmitting PDCP starts transmission of the data packets included in the transmission window from the beginning and transmits a data packet PDCP-PDU with sequence number N to the transmitting RLC (632). The transmitting RLC forwards this to the receiving RLC (634), which acknowledges the received data packet and transmits it to the PDCP layer (636). The transmitter's counter has provided this data packet with sequence number N, but the value of the transmitter's counter is N+M that was updated earlier (638).

The sequence number counters of the transmitter and the receiver are thus asynchronous, and reliability of data transmission cannot be guaranteed. The situation described above, in particular, causes the problem that at least some of the data packets N+1−M are transmitted twice to the receiver. Forwarding of these duplicates to the next protocol layer consumes the network capacity. Furthermore, the application of the receiving mobile station UE using the data packet connection should be able to process the data packets received as duplicates, which makes implementation of the application more difficult.

According to a preferred embodiment, if the value of the transmitter's sequential counter transmitted to the receiver by means of RRC signalling is smaller than the value of the receiver's sequence number counter, a temporary counter is always used in connection with reconfiguration of the radio bearer or resetting of the RLC layer. The value of the receiver's sequence number counter is stored in memory and the value of the transmitter's sequence number counter is set as the value of the temporary counter. The value of the temporary counter is increased each time a new PDCP-PDU data packet is transmitted from the RLC layer or when the RLC layer transmits information that one or more data packets have been rejected in the RLC layer according to the rejection process described above. When the value of the temporary counter reaches the value of the receiver's sequence number counter stored in memory, the temporary counter is removed or attached to the sequence number counter of the original receiver. It is presumed that the data packets PDCP-PDU received during the use of the temporary counter are duplicates of the data packets received earlier and they are destroyed in the receiver's PDCP layer, and thus no duplicates are transmitted to the upper protocol layers. Received data packets are destroyed until the temporary counter is removed. Neither the RLC layer nor the radio resource control protocol RRC needs to be informed that data packets regarded as duplicates will be destroyed.

Thanks to the method according to the invention, error situations resulting from the fact that the applications used by a terminal are unable to process duplicate data packets transmitted from the lower layers can be avoided in terminals. According to the method of the invention, the PDCP layer transmits only data packets, such as IP packets, that have not been transmitted earlier to the upper layers. Neither are duplicate data packets forwarded from the PDCP layer for transmission to the core network CN in the radio network UTRAN, which reduces the load on the radio resources. This is particularly important when the transmission is received by another mobile station because the load on the limited resources of the air interface can be reduced.

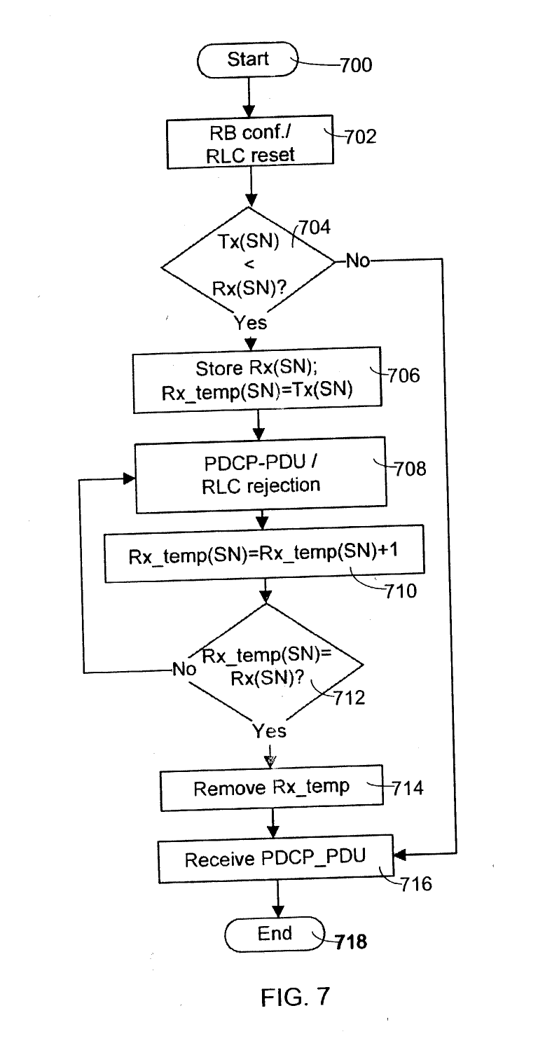

The embodiment described above is also illustrated in FIG. 7. During reconfiguration of the radio bearer or reset of the RLC layer (702) it is checked whether the value of the transmitter's sequence number counter Tx(SN) is smaller than the value of the receiver's sequence number counter Rx(SN). If the value is smaller, the value of the receiver's sequence number counter Rx(SN) is stored in memory, a temporary counter Rx_temp(SN) is created and the value of the transmitter's sequence number counter Tx(SN) is set as its value (706). A new data packet PDCP-PDU is transmitted from the RLC layer or the RLC layer transmits information that the data packet has been rejected (708). In response to this, one is added to the value of the temporary counter Rx_temp(SN) (710). After this, the value of the temporary counter Rx_temp(SN) is compared with the value of the receiver's sequence number counter Rx(SN) stored in memory (712), and if the value is still smaller, the process returns to step in which a data packet is received (708). This is repeated until Rx_temp(SN)=Rx(SN), after which the temporary counter Rx_temp(SN) can be removed (714) and reception of data packets can continue normally (716). If it is noted in the preceding check (704) that the value of the transmitter's sequence number counter Tx(SN) is not smaller than the value of the receiver's sequence number counter Rx(SN),normal reception of data packets can be continued directly (716).

It is also possible that as a result of asynchronization of the sequence number counters, e.g. after reset of the RLC layer, the counters are to be synchronized by sending convergence protocol packets which include a data packet number, i.e. PDCP-SeqNum-PDUs and by indicating the number of these convergence protocol packets to the receiver by some mechanism. According to another embodiment, if the value of the transmitter's sequence number counter transmitted to the receiver is smaller than the value of the receiver's sequence number counter, the temporary counter described above is not needed at all, but the value of the receiver's sequence number counter is stored in memory and the data packet number of each received convergence protocol packet is compared with the value of the receiver's sequence number counter. It is presumed that each received PDCP-SeqNum-PDU data packet with a data packet number smaller than the value of the receiver's sequence number counter is a duplicate of a data packet received earlier and it is destroyed in the receiver's PDCP layer.

This embodiment also provides the advantage described above, i.e. no duplicates are transmitted to the upper protocol layers. It is also unnecessary to inform the RLC layer that data packets regarded as duplicates will be destroyed.

The embodiments described above can also be implemented so that the counter value or the data packet number of a transmitted convergence protocol packet is compared to a predetermined value other than the original value of the receiver's sequence number counter. It is possible to add e.g. 10 to the original value of the receiver's sequence number counter, and thus synchronization of the sequence number counters can be guaranteed even better.

It is obvious to a person skilled in the art that as the technology advances, the inventive concept can be implemented in various ways. The invention and its embodiments are thus not limited to the examples described above but may vary within the scope of the claims.

1. A method for acknowledged transmission of data packets in a packet-switched telecommunications system, the telecommunications protocol of which comprises a convergence protocol layer (PDCP) for converting user data packets into convergence protocol packets, and a link layer (RLC) for transmitting convergence protocol packets (PDCP-PDU) as data units (RLC-PDU) and for acknowledging the transmission, the method comprising
a) defining a data packet number for the convergence protocol packets to be transmitted by means of counters of the transmitter and the receiver which are synchronized with each other, in which case the transmitted convergence protocol packets are acknowledged by means of the values of said counters,
b) reconfiguring a radio bearer or the link layer,
c) comparing the values of said counters of the transmitter and the receiver with each other,
d) starting a temporary counter for the receiver in response to the value of the transmitter's counter being smaller than the value of the receiver's counter,
e) setting the value of the transmitter's counter as the value of the temporary counter, and
f) using the temporary counter until its value reaches a predetermined value.

2. A method according to claim 1, further comprising
destroying the data packets received in the convergence protocol layer during the use of the temporary counter.

3. A method according to claim 1, wherein
said predetermined value is the value of the receiver's original counter.

4. A method according to claim 1, wherein step e) is followed by the steps of
g) adding one to the value of the temporary counter in response to the data packet received in the receiver's convergence protocol layer or to a notification of rejection of the data packet in the link layer,
h) comparing the value of the temporary counter with said predetermined value, and
i) repeating steps g) and h) until the value of the temporary counter is equal with said predetermined value.

5. A method according to claim 1, wherein step f) is followed by the step of
j) removing the temporary counter or adding it to the receiver's original counter.

6. A packet-switched telecommunications system, the telecommunications protocol of which comprises a convergence protocol layer (PDCP) for converting user data packets into convergence protocol packets, and a link layer (RLC) for transmitting convergence protocol packets (PDCP-PDU) as data units (RLC-PDU) and for acknowledging the transmission, wherein the system is arranged to
a) define a data packet number for the convergence protocol packets to be transmitted by means of counters of the transmitter and the receiver which are synchronized with each other, in which case the transmitted convergence protocol packets are arranged to be acknowledged by means of the values of said counters,
b) reconfigure a radio bearer or the link layer,
c) compare the values of said counters of the transmitter and the receiver with each other,
d) start a temporary counter for the receiver in response to the value of the transmitter's counter being smaller than the value of the receiver's counter,
e) set the value of the transmitter's counter as the value of the temporary counter, and
f) use the temporary counter until its value reaches a predetermined value.

7. A system according to claim 6, wherein the system is further arranged to
destroy the data packets received in the convergence protocol layer during the use of the temporary counter.

8. A system according to claim 6, wherein
said predetermined value is the value of the receiver's original counter.

9. A system according to the claim 6, wherein step e) is followed by the steps wherein the system is arranged to
g) add one to the value of the temporary counter in response to the data packet received in the receiver's convergence protocol layer or to a notification of rejection of the data packet in the link layer,
h) compare the value of the temporary counter with said predetermined value, and
i) repeat steps g) and h) until the value of the temporary counter is equal with said predetermined value.

10. A system according to the claim 6, wherein step f) is followed by the step wherein the system is arranged to
remove the temporary counter or adding it to the receiver's original counter.
